(19) United States
(12) Patent Application Publication
(10) Pub. No.: US 2016/0299368 A1
(43) Pub. Date: Oct. 13, 2016

(54) LIQUID CRYSTAL DISPLAY AND MANUFACTURING METHOD THEREOF

(71) Applicant: Samsung Display Co., Ltd, Yongin-si (KR)

(72) Inventor: Han Su KIM, Seoul (KR)

(21) Appl. No.: 15/040,896

(22) Filed: Feb. 10, 2016

(30) Foreign Application Priority Data
Apr. 13, 2015 (KR) 10-2015-0052018

(51) Int. Cl. G02F 1/1341; G02F 1/1335; G02F 1/1343; G02F 1/1333

(52) U.S. Cl. CPC G02F 1/1341; G02F 1/133377; G02F 1/133526; G02F 1/13439; G02F 1/133345

(57) ABSTRACT

Disclosed is a liquid crystal display, including: an insulation substrate; a microcavity formed on the insulating substrate and having an upper surface and sides; a liquid crystal layer injected into the microcavity; liquid crystal injection holes formed on one side of the microcavity to inject a liquid crystal into the microcavity; and a capping layer formed on the microcavity and having an upper surface patterned to form an arrangement of lenticular lenses.

### CROSS-REFERENCE TO RELATED APPLICATION

This application claims priority to and the benefit of Korean Patent Application No. 10-2015-0052018 filed in the Korean Intellectual Property Office on Apr. 13, 2015, the entire contents of which are incorporated herein by reference.

### BACKGROUND

(a) Field

Embodiments of the present disclosure relate to a liquid crystal display and a manufacturing method thereof, and more particularly, to a liquid crystal display and a manufacturing method thereof capable of implementing an autostereoscopic three-dimensional representation.

(b) Description of the Related Art

Generally, a stereoscopic image in 3D is implemented based on a principle of stereo vision by two eyes. That is, a three-dimensional effect can be realized due to a disparity, called binocular disparity, between the two eyes, which are spaced apart from each other by as much as about 65 mm. That is, left and right eyes each see different 2D images, and when the two images are transferred to the brain through the retinas, the brain fuses the two images with each other to reproduce original depth and reality of the 3D image. The ability is generally referred to as stereography.

A stereoscopic image display uses the binocular disparity and may be classified into a stereoscopic polarization type, a stereoscopic time division type, an autostereoscopic parallax-barrier type, a lenticular type, or a blinking light type depending on whether an observer wears separate glasses

The autostereoscopic stereoscopic image display uses an apparatus for separating a left-eye image and a right-eye image, like a lenticular lens layer on a liquid crystal display. The autostereoscopic stereoscopic image display has an advantage of providing the stereoscopic image without an observer additionally using glasses since the observer directly fixes his/her eyes on a screen. However, separately from a manufacturing process of a liquid crystal display, an additional process of separately providing the lenticular lens layer and attaching the lenticular lens layer on the liquid crystal display is required.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to provide a liquid crystal display and a manufacturing method thereof having advantages of omitting a process of additionally attaching a separate lenticular lens layer by providing a capping layer of the liquid crystal display in a form of the lenticular lens.

An exemplary embodiment of the present disclosure provides a liquid crystal display, including: an insulation substrate; a microcavity formed on the insulating substrate and having an upper surface and sides; a liquid crystal layer injected into the microcavity; liquid crystal injection holes formed on one side of the microcavity to inject a liquid crystal into the microcavity; and a capping layer formed on the microcavity and having an upper surface patterned to form an arrangement of lenticular lenses.

A lower surface of the capping layer may be patterned in an engaging shape corresponding to a shape of the liquid crystal injection hole, and the liquid crystal injection hole may be encapsulated with the capping layer.

The upper surface of the capping layer may include a plurality of lenticular lens parts extending in a vertical direction.

Any one of the plurality of lenticular lens parts may cover a plurality of pixel areas disposed in a horizontal direction.

Any one of the plurality of lenticular lens parts may cover a plurality of points of view.

The liquid crystal display may further include: a pixel electrode formed in the microcavity; and a common electrode positioned on the liquid crystal layer, in which the common electrode extends along the upper surface and the sides of the microcavity.

The common electrode may be formed in plural.

The liquid crystal display may further include: a roof layer covering the common electrode.

Another exemplary embodiment of the present disclosure provides a manufacturing method of a liquid crystal display, including: stacking a material for a sacrificial layer; forming the sacrificial layer by etching the material for the sacrificial layer; forming common electrodes which extend along an upper surface and sides of the sacrificial layer; forming a roof layer covering the sacrificial layer; forming a liquid crystal injection hole through which the sacrificial layer is exposed; forming a microcavity by removing the sacrificial layer through the liquid crystal injection hole; forming a liquid crystal layer in the microcavity through the liquid crystal injection hole; and covering the microcavity with a capping layer of which the upper surface is patterned to form an arrangement of lenticular lenses.

A lower surface of the capping layer may be patterned in an engaging shape corresponding to a shape of the liquid crystal injection hole, and the liquid crystal injection hole may be encapsulated with the capping layer.

The upper surface of the capping layer may include a plurality of lenticular lens parts extending in a vertical direction.

Any one of the plurality of lenticular lens parts may cover a plurality of pixel areas disposed in a horizontal direction.

Any one of the plurality of lenticular lens parts may cover a plurality of points of view.

The manufacturing method may further include: forming a pixel electrode of a transparent conductive material in a lower portion of the sacrificial layer.

The manufacturing method may further include: prior to forming the liquid crystal layer in the microcavity, forming an alignment layer in the microcavity through the liquid crystal injection hole.

The sacrificial layers formed in the forming of the sacrificial layers may be formed lengthwise along vertically adjacent pixels.

The roof layer may not be formed in a region in which the liquid crystal injection hole is formed.

The manufacturing method may further include: forming a lower insulating layer covering the common electrode prior to forming the roof layer; and forming an upper insulating layer covering the roof layer and the exposed lower insulating layer after forming the roof layer.

The forming of the liquid crystal injection hole may include etching the common electrode, the lower insulating layer, and the upper insulating layer.

According to an exemplary embodiment of the present disclosure, it is possible to omit the process of additionally attaching the separate lenticular lens layer for the autostereoscopic stereoscopic image display.

### BRIEF DESCRIPTION OF THE DRAWINGS

FIG. 1 is a layout view of a liquid crystal display according to an exemplary embodiment of the present disclosure.

FIG. 2 is a cross-sectional view taken along the line II-II of FIG. 1.

FIG. 3 is a cross-sectional view taken along the line III-III of FIG. 1.

FIGS. 4, 5, 6, 7A, 7B, 8A, 8B, 9A, 9B, 9C, 9D, 10A, 10B, 100, 10D, 11A, 11B, 11C, 11D, 12A, 12B, 12C, 12D, 13A, 13B, 13C, 13D, 13E, 14, 15 and 16A, 16B, and 16C are diagrams sequentially describing a manufacturing method of the liquid crystal display according to the exemplary embodiment illustrated in FIGS. 1 and 3

### DETAILED DESCRIPTION OF THE EMBODIMENTS

Hereinafter, the present system and method are described more fully hereinafter with reference to the accompanying drawings in which exemplary embodiments of the system and method are shown. As those skilled in the art would realize, the described embodiments may be modified in various different ways, all without departing from the spirit or scope of the present system and method.

Further, in exemplary embodiments, since like reference numerals designate like elements having the same configuration, a first exemplary embodiment is representatively described, and in other exemplary embodiments in which only a configuration is different from the first exemplary embodiment, only the differences are described.

Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

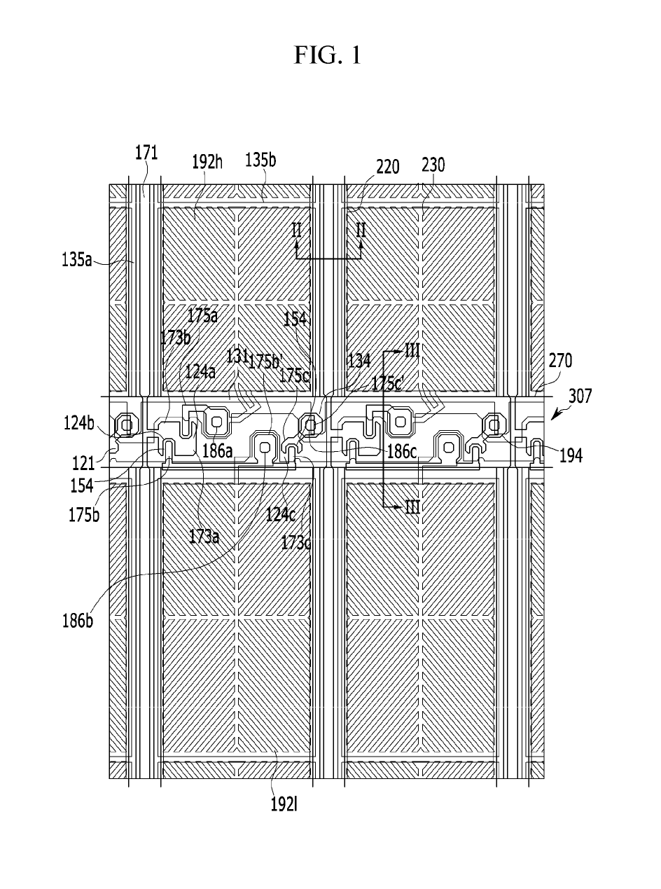

Hereinafter, a liquid crystal display according to an exemplary embodiment of the present disclosure is described in detail with reference to FIGS. 1 to 3.

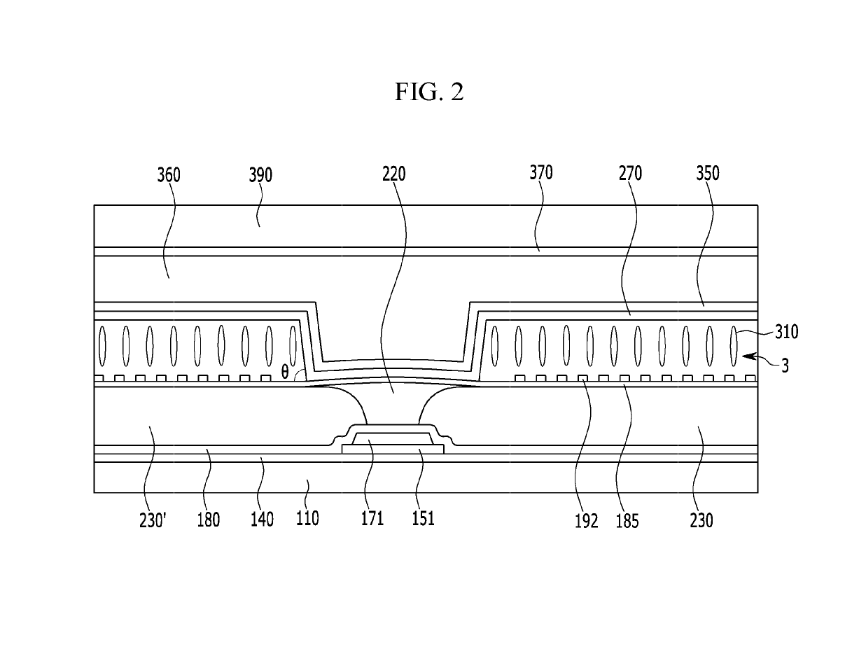

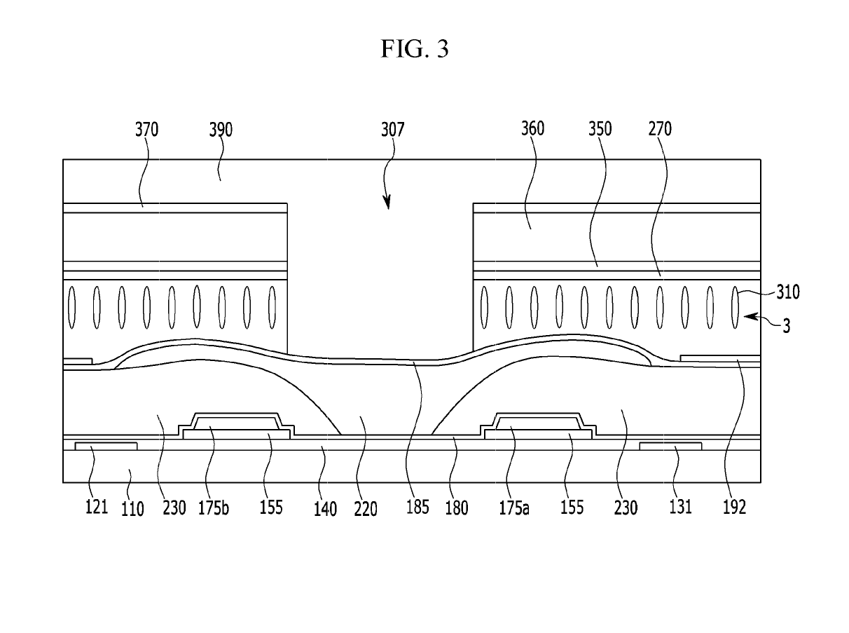

FIG. 1 is a layout view of a liquid crystal display according to an exemplary embodiment of the present disclosure. FIG. 2 is a cross-sectional view taken along the line 11-11 of FIG. 1. FIG. 3 is a cross-sectional view taken along the line 111-111 of FIG. 1.

Referring to FIGS. 1 to 3, a gate line 121 and a sustain voltage line 131 are formed on an insulating substrate 110 made of transparent glass, plastic, or the like. The gate line 121 includes a first gate electrode 124a, a second gate electrode 124b, and a third gate electrode 124c. The sustain voltage line 131 includes storage electrodes 135a and 135b and a protrusion 134 protruding in a direction of the gate line 121. The sustain electrodes 135a and 135b have a structure that encloses a first sub-pixel electrode 192h and a second sub-pixel electrode 1921 of an adjacent pixel.

A horizontal part 135b of the sustain electrode of FIG. 1 may be one wiring that is not separated from the horizontal part 135b of the adjacent pixel.

A gate insulating layer 140 is formed on the gate line 121 and the sustain voltage line 131. A semiconductor 151 disposed beneath a data line 171, a semiconductor 155 disposed beneath source/drain electrodes, and a semiconductor 154 disposed at a channel portion of a thin film transistor are formed on the gate insulating layer 140.

A plurality of ohmic contacts may be formed on each of the semiconductors 151, 154, and 155 and between the data line 171 and the source/drain electrodes, and is omitted in the drawings.

Data conductors 171, 173c, 175a, 175b, 175c including a plurality of data lines 171 including a first source electrode 173a and a second source electrode 173b, a first drain electrode 175a, a second drain electrode 175b, a third source electrode 173c, and a third drain electrode 175c are formed on each of the semiconductors 151, 154, and 155 and the gate insulating layer 140.

The first gate electrode 124a, the first source electrode 173a, the first drain electrode 175a, and the semiconductor 154 together form the first thin film transistor. A channel of the first thin film transistor is formed on the semiconductor 154 between the first source electrode 173a and the first drain electrode 175a. Similarly, the second gate electrode 124b, the second source electrode 173b, the second drain electrode 175b, and the semiconductor 154 together form a second thin film transistor. The channel of the second thin film transistor is formed on the semiconductor 154 between the second source electrode 173b and the second drain electrode 175b. The third gate electrode 124c, the third source electrode 173c, the third drain electrode 175c, and the semiconductor 154 together form a third thin film transistor. The channel of the thin film transistor is formed on the semiconductor 154 between the third source electrode 173c and the third drain electrode 175c.

The data line 171 according to an exemplary embodiment of the present disclosure has a structure in which its width is narrower in a thin film transistor forming region in the vicinity of an extension 175c′ of the third drain electrode 175c. The data line 171 has the structure that maintains an interval from adjacent wirings and reduces signal interference, but is not necessarily formed so.

A first passivation layer 180 is formed on the data conductors 171, 173c, 175a, 175b, and 175c and the exposed semiconductor 154. The first passivation layer 180 may be made of inorganic insulating materials or organic insulating materials, such as silicon nitride (SiNx) and silicon oxide (SiOx).

A color filter 230 is formed on the first passivation layer 180. The color filters 230 having the same color are formed at pixels adjacent in a vertical direction (data line direction). Further, the pixels adjacent in a horizontal direction (gate line direction) may be provided with the color filters 230 and 230′ having different colors, and the two color filters 230 and 230′ may overlap each other over the data line 171. The color filters 230 and 230′ may display one of the primary colors, such as three primary colors of red, green, and blue, and the like. However, the color filters 230 and 230′ may also display one of cyan, magenta, yellow, white-based colors, without being limited to the three primary colors of red, green, and blue.

A black matrix 220 is formed on the color filters 230 and 230′. The black matrix 220 is formed around a region (hereinafter, referred to as a ‘transistor forming region’) in which the gate line 121, the sustain voltage line 131, and the thin film transistor are formed and a region in which the data line 171 is formed. Furthermore, the black matrix is formed in a lattice structure having an opening corresponding to a region in which an image is displayed. The opening of the black matrix 220 is provided with the color filter 230. Further, the black matrix 220 is made of a material through which light is not transmitted.

A second passivation layer 185 is formed on the color filter 230 and the black matrix 220 to cover the color filter 230 and the black matrix 220. The second passivation layer 185 may be made of inorganic insulating materials or organic insulating materials, such as silicon nitride (SiNx) and silicon oxide (SiOx). According to another embodiment different from the one illustrated in the cross-sectional view of FIGS. 2 and 3, when a step occurs due to a difference between a thickness of the color filter 230 and a thickness of the black matrix 220, the second passivation layer 185 includes the organic insulating materials, thereby reducing or removing the step.

The color filter 230, the black matrix 200, and the passivation layers 180 and 185 are provided with a first contact hole 186a and a second contact hole 186b that expose the first drain electrode 175a and extension 175b′ of the second drain electrode 175b, respectively. In addition, the color filter 230, the black matrix 220, and the passivation layers 180 and 185 are provided with a third contact hole 186c that exposes the protrusion 134 of the sustain voltage line 131 and the extension 175c′ of the third drain electrode 175c.

According to an exemplary embodiment of the present disclosure, the black matrix 220 and the color filter 230 are provided with the contact holes 186a, 186b, and 186c, but the etching of the contact holes of the black matrix 220 and the color filter 230 may be more difficult than that of the passivation layers 180 and 185, depending on the material of the black matrix 220 and the color filter 230. Therefore, at the time of etching the black matrix 220 or the color filter 230, the black matrix 220 or the color filter 230 may be previously removed from positions at which the contact holes 186a, 186b, and 186c are formed.

According to an exemplary embodiment of the present disclosure, only the color filter 230 and the passivation layers 180 and 185 may be etched by changing a position of the black matrix 220 to form the contact holes 186a, 186b, and 186c.

The pixel electrode 192 including the first sub-pixel electrode 192h and the second sub-pixel electrode 1921 is formed on the second passivation layer 185. The pixel electrode 192 may be made of transparent conductive materials, such as ITO (indium tin oxide) and IZO (indium zinc oxide).

The first sub-pixel electrode 192h and the second sub-pixel electrode 1921 are adjacent to each other in a column direction, the overall shape thereof is a quadrangle, and the first sub-pixel electrode 192h and the second sub-pixel electrode 1921 each include a cruciform stem part formed of a horizontal stem part and a vertical stem part intersecting the horizontal stem part. The sub-pixel electrode 192h and the second sub-pixel electrode 1921 are divided into four sub-regions by the horizontal stem part and the vertical stem part, and each sub-region includes a plurality of fine branch parts.

The fine branch parts of the first sub-pixel electrode 192h and the second sub-pixel electrode 1921 form an angle of about 40° to 45° with respect to the gate line 121 or the horizontal stem part. The fine branch parts of two adjacent sub-regions may be orthogonal to each other. A width of the fine branch part may be gradually increased, or an interval between the fine branch parts may be different. The first sub-pixel electrode 192h and the second sub-pixel electrode 1921 are physically and electrically connected to the first drain electrode 175a and the second drain electrode 175b, respectively, through the contact holes 186a and 186b and are supplied with data voltage from the first drain electrode 175a and the second drain electrode 175b.

Meanwhile, a connecting member 194 electrically connects the extension 175c′ of the third drain electrode 175c to the protrusion 134 of the sustain voltage line 131 through the third contact hole 186c. As a result, some of the data voltage applied to the second drain electrode 175b is divided by the third source electrode 173c, such that a magnitude of the voltage applied to the second sub-pixel electrode 1921 may be smaller than that of the voltage applied to the first sub-pixel electrode 192h.

Here, the area of the second sub-pixel electrode 1921 may have a size ranging from one to two times than that of the first sub-pixel electrode 192h.

Meanwhile, the second passivation layer 185 may be provided with an opening that collects gas discharged from the color filter 230 and a cover part that is formed on the opening to cover the corresponding opening with the same material as the pixel electrode 192. The opening and the cover part are structures for blocking the gas discharged from the color filter 230 from being transferred to another device, but are not necessarily included.

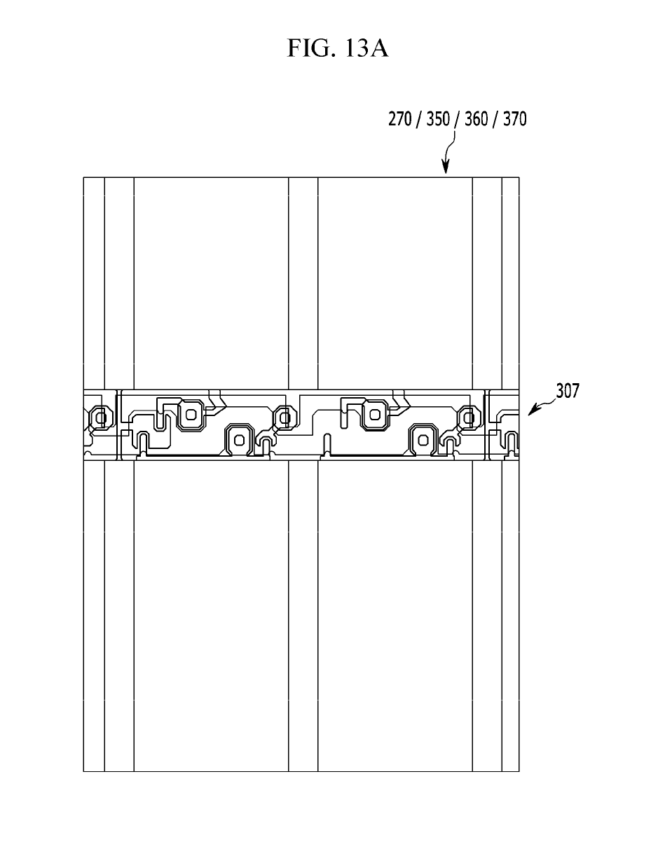

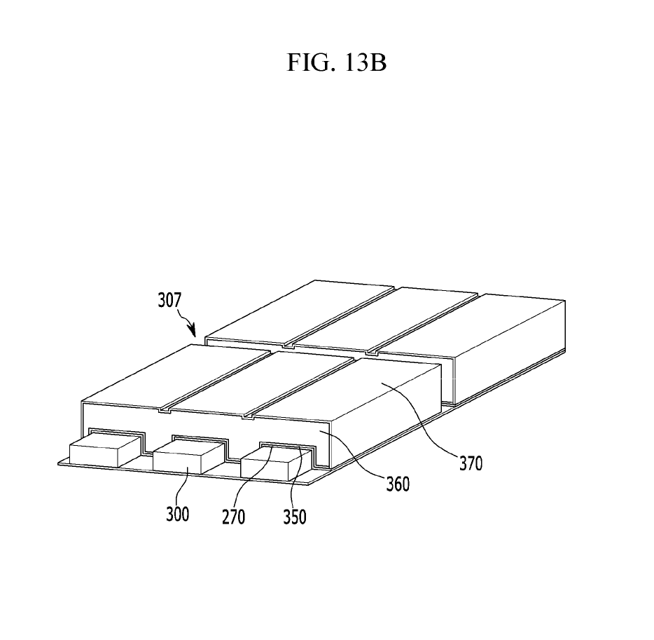

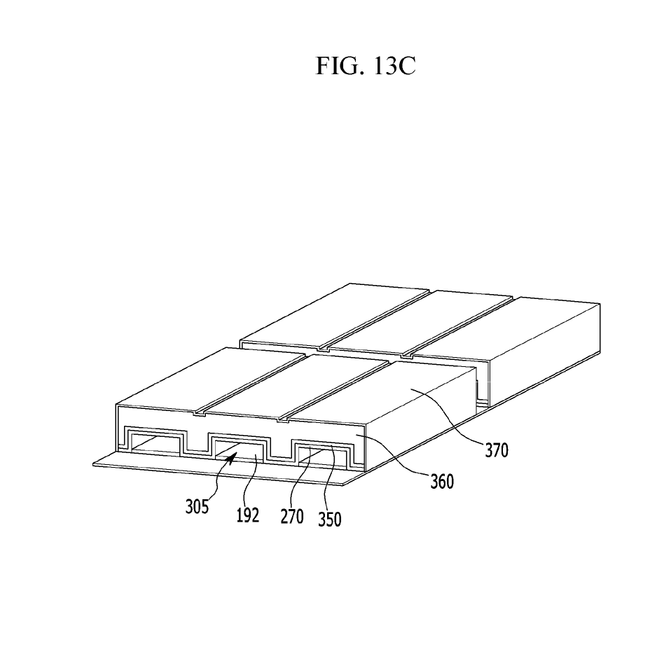

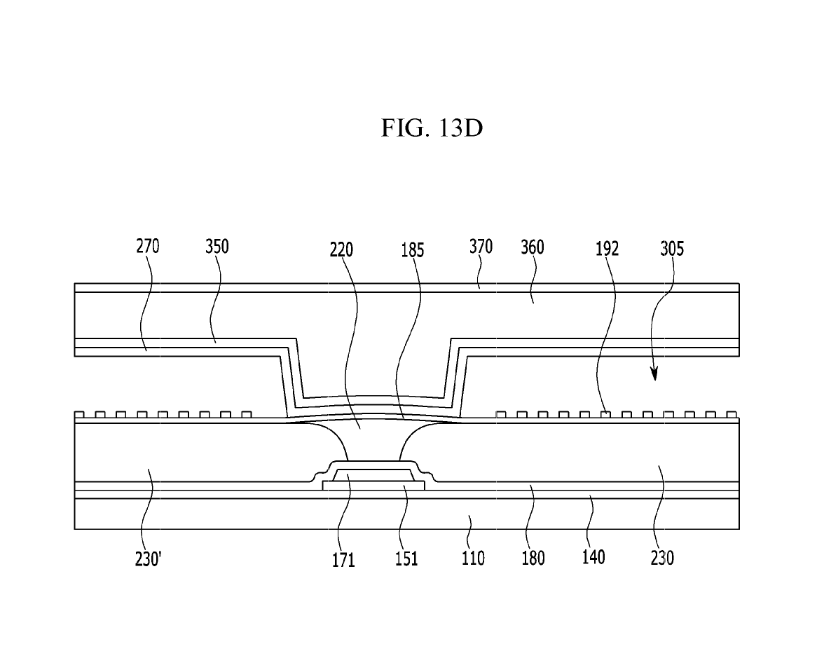

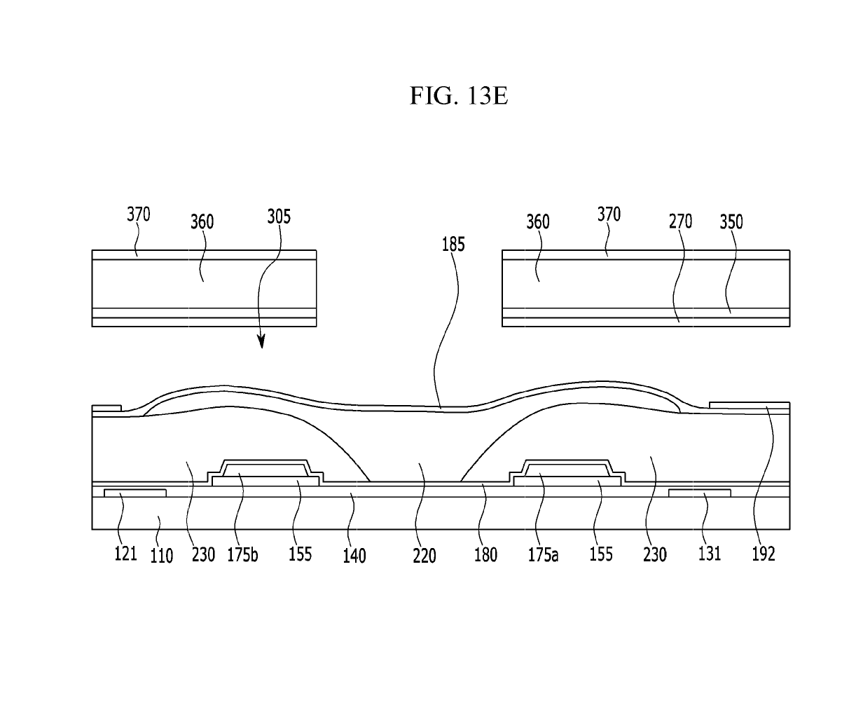

The opening and the cover part are formed on the second passivation layer 185 and the pixel electrode 192 and are provided with a microcavity 305 (see FIGS. 13C, 13D, and 13E).

The microcavity 305 is provided with the liquid crystal layer 3.

An upper surface of the microcavity 305 has a horizontal surface, and sides of the microcavity 305 may have approximately a vertical structure at an angle of 90±10°. The exemplary embodiment of FIG. 2 illustrates a tapered structure in which an angle θ of a side wall ranges from 80° to 90°.

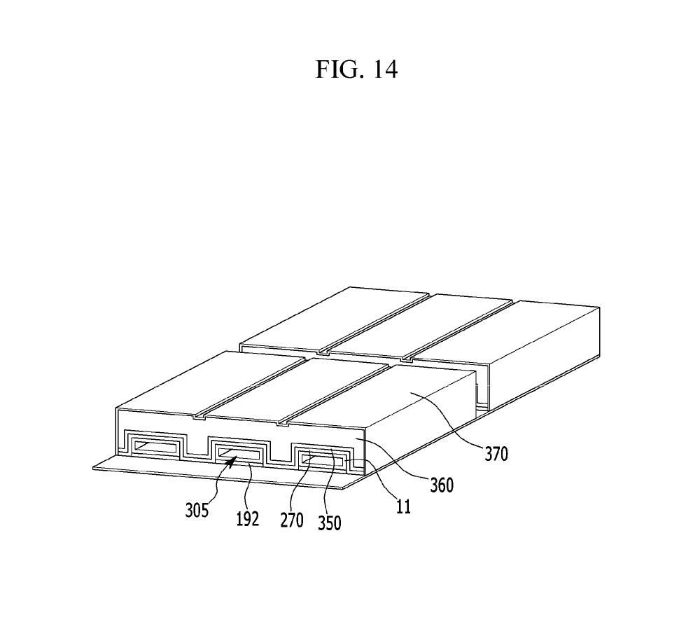

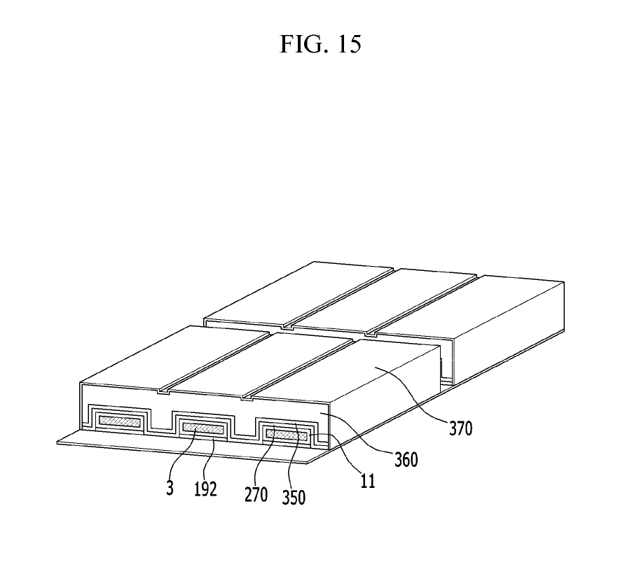

The microcavity 305 is provided with the liquid crystal layer 3. To arrange the liquid crystal molecules 310 injected into the microcavity 305, the inside of the microcavity 305 may be provided with an alignment layer 11 (see FIGS. 14 and 15). The alignment layer 11 may be a liquid crystal alignment layer that includes at least one of polyamic acid, polysiloxane, polyimide, or the like.

The inside of the microcavity 305, or inside of the alignment layer, is provided with the liquid crystal layer 3. The liquid crystal molecules 310 are initially aligned by the alignment layer 11, and an alignment direction thereof is changed depending on the applied electric field. A height of the liquid crystal layer 3 corresponds to that of the microcavity 305. The liquid crystal layer 3 positioned in the microcavity 305 is also called nano crystal.

The alignment layer 11 and the liquid crystal layer 3, which are formed in the microcavity 305, may be injected into the microcavity 305 using a capillary force.

A common electrode 270 is positioned on the second passivation layer 185 and the pixel electrode 192 and on the liquid crystal layer 3 that is injected into the microcavity 305. The common electrode 270 extends along an upper surface and sides of the microcavity 305 or the liquid crystal layer 3, and an extending direction thereof is the same as the extending direction of the gate line 121. The common electrode 270 may keep a horizontal state even on the microcavity because the common electrode 270 is supported by a roof layer 360, which is described below.

Further, the common electrode 270 may be formed as a plurality of common electrodes separated from each other around a liquid crystal injection hole 307, and the plurality of common electrodes 270 may be formed at a predetermined distance from each other. The plurality of common electrodes 270 may be connected to each other at a portion from which the liquid crystal injection hole 307 is excluded.

The common electrode 270 is made of transparent conductive materials, such as ITO, IZO, and the like and generates an electric field along with the pixel electrode 192 to control the alignment direction of the liquid crystal molecules 310.

A lower insulating layer 350 is positioned on the common electrode 270 and the second passivation layer 185 and on sides (or sides of the microcavity 305) of the liquid crystal layer 3. The lower insulating layer 350 may include inorganic insulating materials such as silicon nitride (SiNx).

The roof layer 360 is formed on the lower insulating layer 350 and may be made of organic materials. The roof layer 360 may serve as a support to form a space (microcavity) between the pixel electrode 192 and the common electrode 270 in which the nano liquid crystal is disposed.

The upper insulating layer 370 is formed on the roof layer 360. The upper insulating layer 370 may include inorganic insulating materials such as silicon nitride (SiNx).

The lower insulating layer 350, the roof layer 360, and the upper insulating layer 370 may have the liquid crystal injection hole 307 positioned on one side thereof to inject a liquid crystal into the microcavity 305. The liquid crystal injection hole 307 may be used even when a sacrificial layer for forming the microcavity 305 is removed.

The liquid crystal injection hole 307 has a trench shape in a horizontal direction (gate line direction).

According to an exemplary embodiment of the present disclosure, the lower insulating layer 350 and the upper insulating layer 370 may be omitted. The capping layer 390 is formed on the upper insulating layer 370. That is, the capping layer 390 is formed on the microcavity 305. The capping layer 390 may encapsulate the liquid crystal injection hole 307. That is, the capping layer 390 seals the liquid crystal injection hole 307 and blocks the liquid crystal molecules 310 from leaking to the outside. As illustrated in FIGS. 2 and 3, the capping layer 390 may be formed to cover the whole upper surface of the insulating substrate 110. The capping layer 390 may be made of an insulating material that does not react with the liquid crystal molecules 310. According to an exemplary embodiment of the present disclosure, an inorganic layer (not illustrated) that encapsulates the liquid crystal injection hole 307 is formed on the upper insulating layer 370, and the capping layer 390 may also be formed on the inorganic layer.

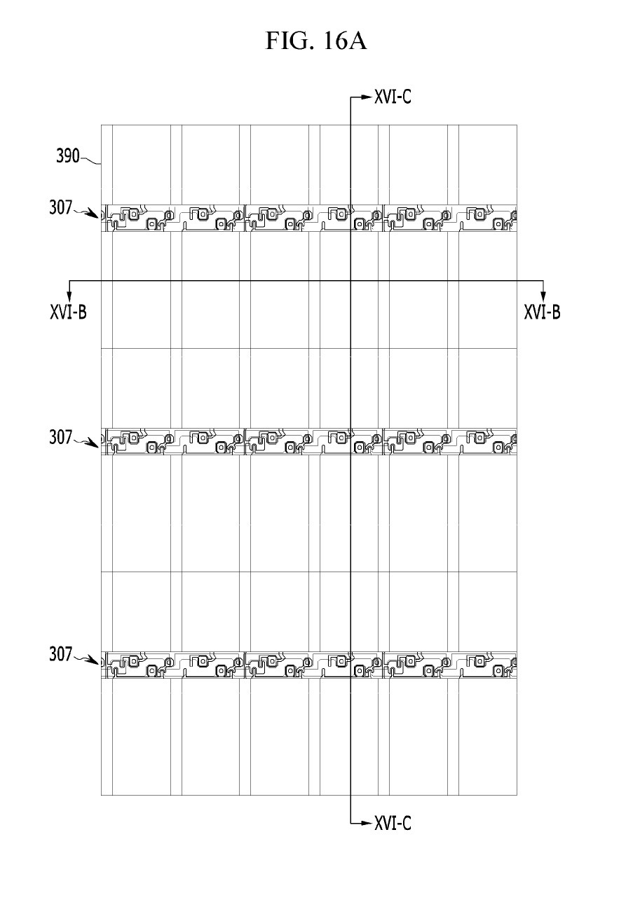

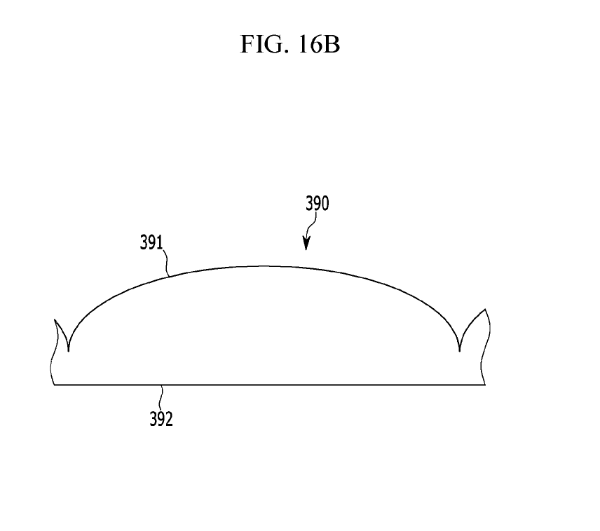

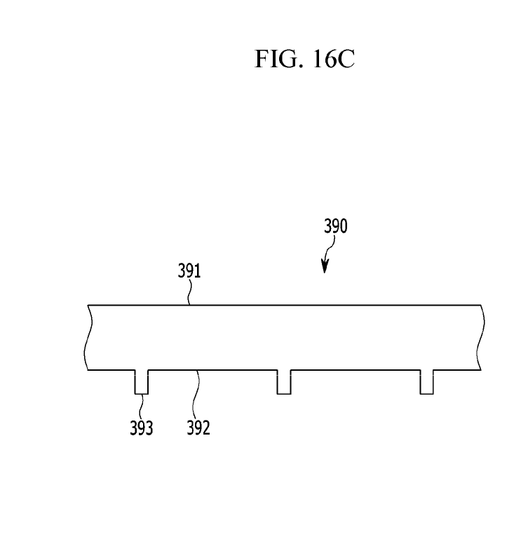

The capping layer 390 may be provided as a film of which the lower surface is patterned in an engaging shape corresponding to the trench shape of the liquid crystal injection hole 307, and the upper surface is patterned to form an arrangement of lenticular lenses for displaying autostereoscopic images. The engaging shape of the lower surface of the capping layer 390 includes a horizontal part 392 (see FIG. 16C) that contacts the upper insulating layer 370, and a plurality of engaging parts 393 (see FIG. 16C) that extends in a horizontal direction (with respect to FIG. 1). The arrangement shape of the lenticular lenses on the upper surface of the capping layer 390 includes a plurality of lenticular lens parts 391 (see FIG. 16B) that extends in a vertical direction (with respect to FIG. 1). Each of the lenticular lens parts 391 covers a plurality of pixel areas in the horizontal direction. The pixel area refers to an area in which the pixel electrode 192 including the first sub-pixel electrode 192h and the second sub-pixel electrode 1921 is formed.

The capping layer 390 is positioned on the upper insulating layer 370 so that the engaging part 393 of the capping layer 390 engages with the liquid crystal injection hole 307, thereby forming the lenticular lens layer for displaying the stereoscopic image while encapsulating the liquid crystal injection hole 307.

When the upper surface of the capping layer 390 forms a horizontal surface like the lower surface of the insulating substrate 110, the lenticular lens layer may be additionally attached. However, according to the above-described exemplary embodiment of the present disclosure, the upper surface of the capping layer 390 is patterned in the arrangement shape of the lenticular lenses, and therefore, a separate process of additionally attaching the lenticular lens layer may be omitted.

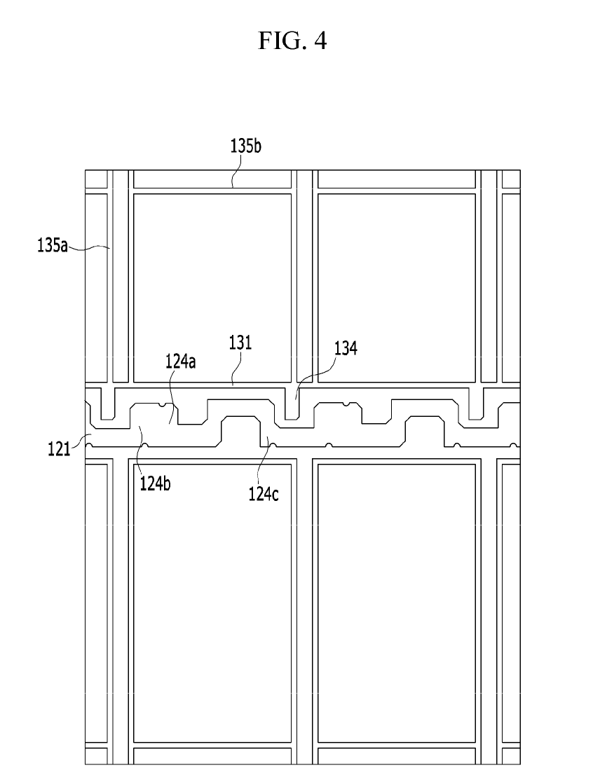

A polarizer (not illustrated) may be positioned on the lower portion of the insulating substrate 110 and the upper portion of the capping layer 390. The polarizer may include a polarization element generating polarization and a tri-acetyl-cellulose (TAC) layer for securing durability. According to some exemplary embodiments of the present disclosure, an upper polarizer and a lower polarizer have transmissive axes of which the direction may be vertical to or parallel with each other. Hereinafter, a manufacturing method of a liquid crystal display according to an exemplary embodiment of the present disclosure is described with reference to FIGS. 4 to 16.

FIGS. 4 to 16 are diagrams sequentially describing a manufacturing method of the liquid crystal display according to the exemplary embodiment illustrated in FIGS. 1 to 3.

First, FIG. 4 is a layout view in which the gate line 121 and the sustain voltage line 131 are formed on the insulating substrate 110.

Referring to FIG. 4, the gate line 121 and the sustain voltage line 131 are formed on the insulating substrate 110 made of transparent glass, plastic, or the like. The gate line 121 and the sustain voltage line 131 may be made of the same material by the same mask during the same process step. Further, the gate line 121 includes the first gate electrode 124a, the second gate electrode 124b, and the third gate electrode 124c, and the sustain voltage line 131 includes sustain electrodes 135a and 135b and a protrusion 134 that protrudes in a direction towards the gate line 121. The sustain electrodes 135a and 135b have a structure that encloses a first sub-pixel electrode 192h and a second sub-pixel electrode 1921 of a front pixel. The gate line 121 is applied with a gate voltage, and the sustain voltage line 131 is applied with a sustain voltage, and therefore, the gate line 121 and the sustain voltage line 13 are formed to be spaced apart from each other. The sustain voltage may have a constant voltage level or a swinging voltage level.

A gate insulating layer 140 is formed on the gate line 121 and the sustain voltage line 131 to cover the gate line 121 and the sustain voltage line 131.

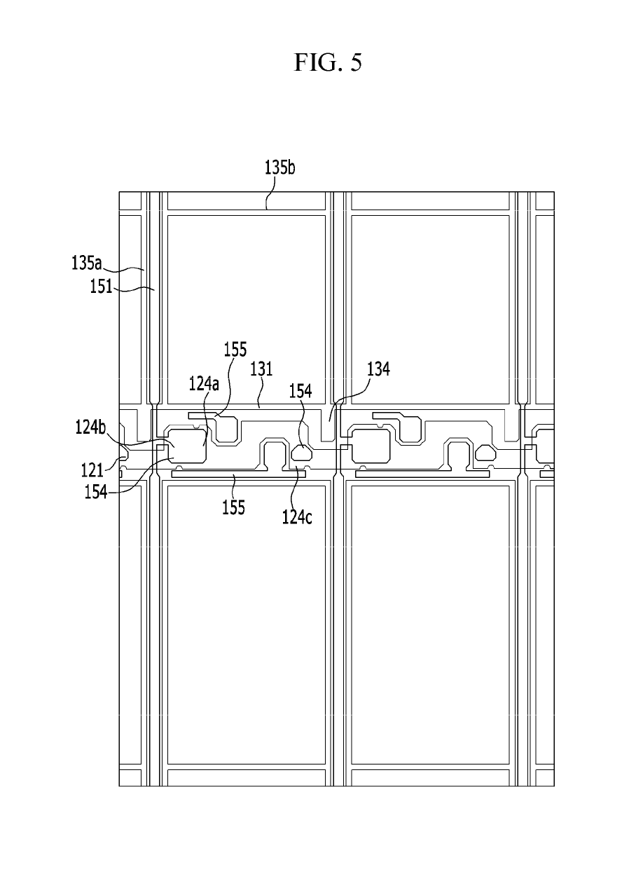

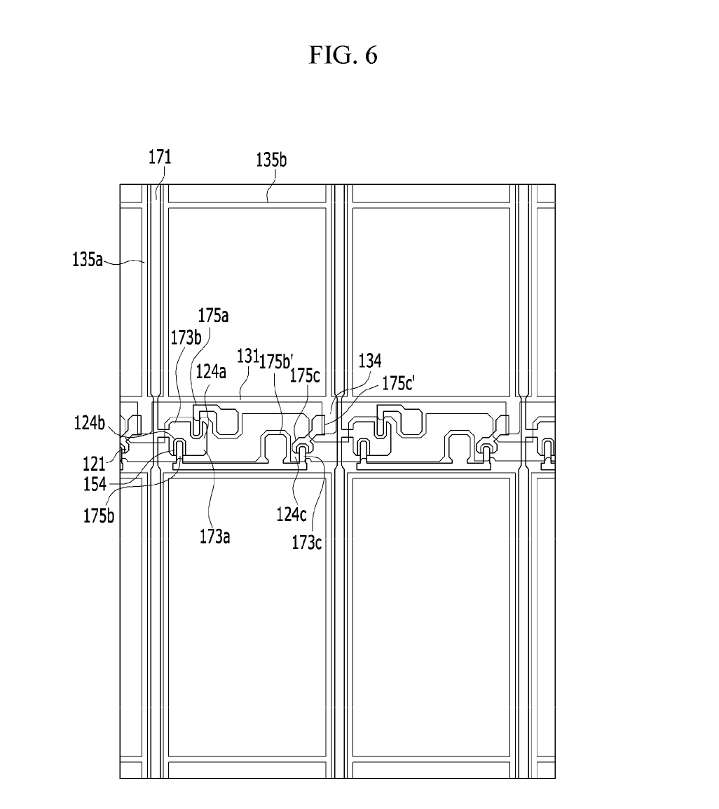

Next, as illustrated in FIGS. 5 and 6, the semiconductors 151, 154, and 155, the data line 171, and the source/drain electrodes 173a, 173b, 173c, 175a, 175b, and 175c are formed on the gate insulating layer 140.

FIG. 5 illustrates a layout view in which the semiconductors 151, 154, and 155 are formed, and FIG. 6 illustrates a layout view in which the data line and the source/drain electrodes 173a, 173b, 173c, 175a, 175b, and 175c are formed. The semiconductors 151, 154, and 155, the data line 171, and the source/drain electrodes 173a, 173b, 173c, 175a, 175b, and 175c may be formed together by the following process.

That is, the material forming the semiconductor and the material forming the data line/source/drain electrodes are sequentially stacked. Next, the two patterns are formed together by a one-time process that performs exposure, developing, and etching through a single mask (slit mask or halftone mask). In this case, to prevent the semiconductor 154 positioned at the channel portion of the thin film transistor from being etched, the corresponding portion is exposed through the slit or the halftone region of the mask.

In this case, a plurality of ohmic contacts may be formed on each of the semiconductors 151, 154, and 155 and between the data line 171 and the source/drain electrodes.

The first passivation layer 180 is formed over the whole area of the data conductors 171, 173c, 175a, 175b, and 175c and the exposed semiconductor 154. The first passivation layer 180 may be made of inorganic insulating materials or organic insulating materials, such as silicon nitride (SiNx) and silicon oxide (SiOx).

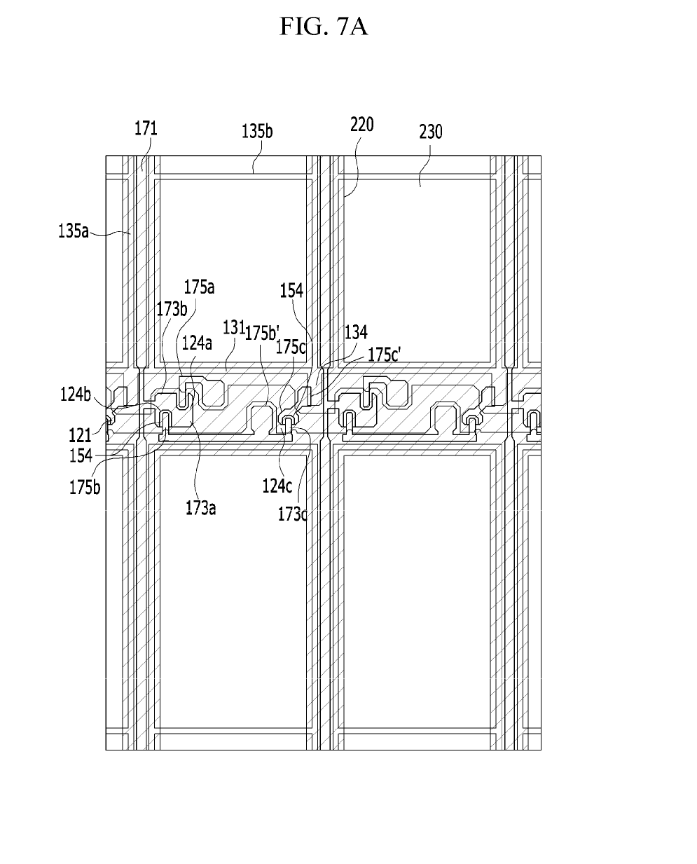

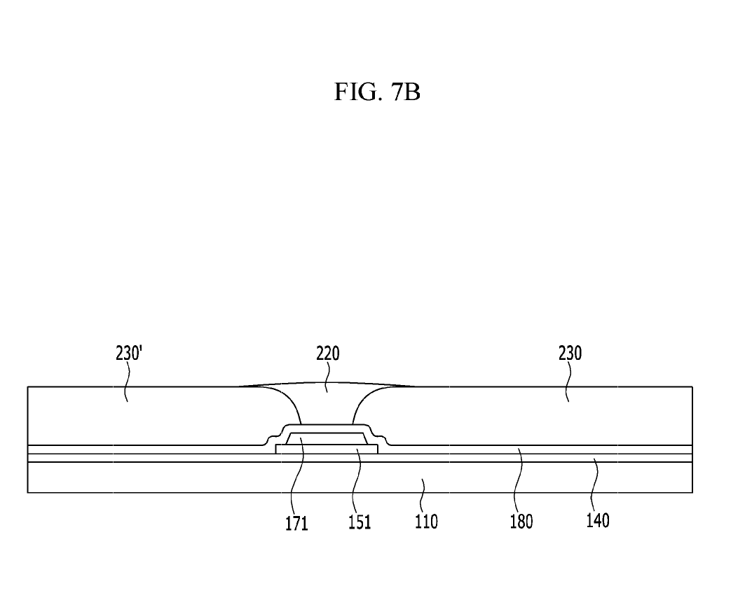

Next, as illustrated in FIGS. 7A and 7B, the color filter 230 and the black matrix 220 are formed on the first passivation layer 180. Here, FIG. 7A is a layout view corresponding to FIG. 1, and FIG. 7B is a cross-sectional view corresponding to FIG. 2. FIG. 7B illustrates the color filter 230 ad the black matrix 220, which are formed after the exposure and the etching.

In forming the color filter 230 and the black matrix 220, the color filter 230 is first formed. The color filter 230 of one color is formed in a vertical direction (data line direction), and pixels adjacent in a horizontal direction (gate line direction) are provided with the color filters 230 and 230′ of different colors. As the result, the exposing, developing, and etching processes are performed on each color filter 230 of each color. For example, a liquid crystal display including three primary colors goes through the exposing, developing, and etching processes three times to form the color filters 230. In this case, the color filter 230′ that is first formed on the data line 171 is positioned in the lower portion, and the color filter 230 that is formed later may overlap the color filter 230′ while being positioned in the upper portion.

At the time of etching the color filter 230, the color filter 230 may also be removed in advance at the positions where the contact holes 186a, 186b, and 186c are formed.

The black matrix 220 that is made of a material preventing light from being transmitted is formed on the color filter 230. Referring to a shaded portion (representing the black matrix 220) of FIG. 7A, the black matrix 220 is formed in a lattice structure having the opening corresponding to the region in which the image is displayed. The color filter 230 is formed in the opening.

As illustrated in FIG. 7A, the black matrix 220 has a portion formed in the horizontal direction along the transistor forming region in which the gate line 121, the sustain voltage line 131, and the thin film transistor are formed and a portion formed in a vertical direction in the region in which the data line 171 is formed.

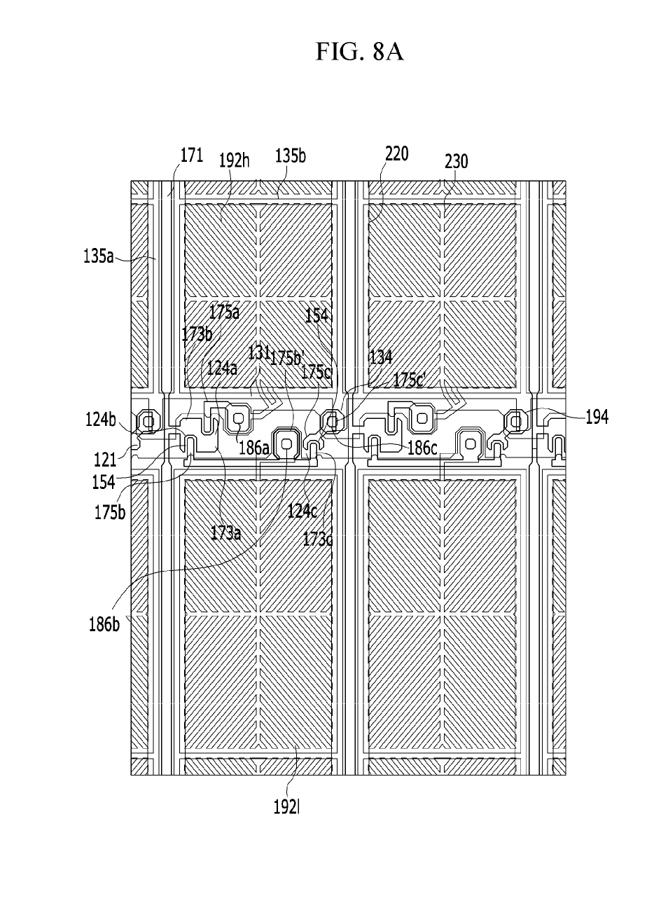

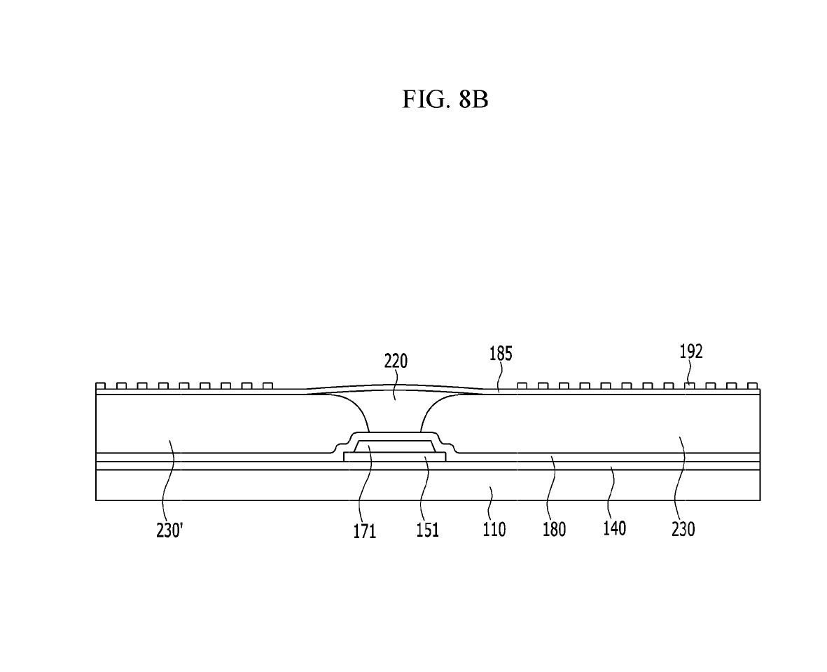

Referring to FIGS. 8A and 8B, the second passivation layer 185 is formed over the whole area of the color filter 230 and the black matrix 220. The second passivation layer 185 may be made of inorganic insulating materials or organic insulating materials, such as silicon nitride (SiNx) and silicon oxide (SiOx). Here, FIG. 8A is a layout view corresponding to FIG. 1, and FIG. 8B is a diagram corresponding to FIG. 2 and illustrates a cross-sectional view of the liquid crystal display that is formed up to FIG. 8A.

Next, the color filter 230, the black matrix 200, and the passivation layers 180 and 185 are provided with a first contact hole 186a and a second contact hole 186b that expose the first drain electrode 175a and extension 175b′ of the second drain electrode 175b, respectively. In addition, the color filter 230, the black matrix 220, and the passivation layers 180 and 185 are provided with a third contact hole 186c that exposes the protrusion 134 of the sustain voltage line 131 and the extension 175c′ of the third drain electrode 175c.

Next, the pixel electrode 192 including the first sub-pixel electrode 192h and the second sub-pixel electrode 1921 is formed on the second passivation layer 185. In this case, the pixel electrode 192 may be made of transparent conductive materials, such as ITO and IZO. Further, the first sub-pixel electrode 192h and the second sub-pixel electrode 1921 each are physically and electrically connected to the first drain electrode 175a and the second drain electrode 175b through the contact holes 186a and 186b, respectively. Further, the connecting member 194 that electrically connects the extension 175c′ of the third drain electrode 175c to the protrusion 134 of the sustain voltage line 131 through the third contact hole 186c is also formed. As the result, some of the data voltage applied to the second drain electrode 175b is divided by the third source electrode 173c, such that a magnitude of the voltage applied to the second sub-pixel electrode 1921 may be smaller than that of the voltage applied to the first sub-pixel electrode 192h.

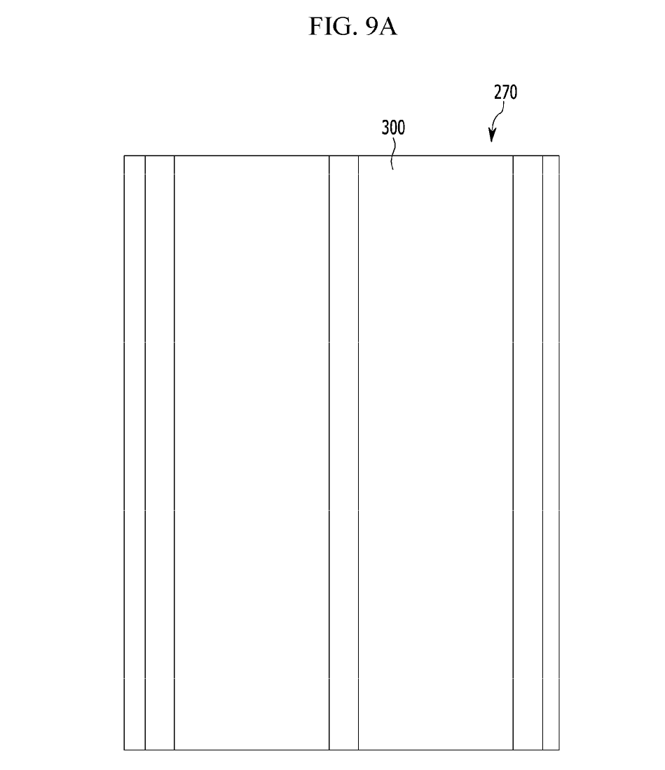

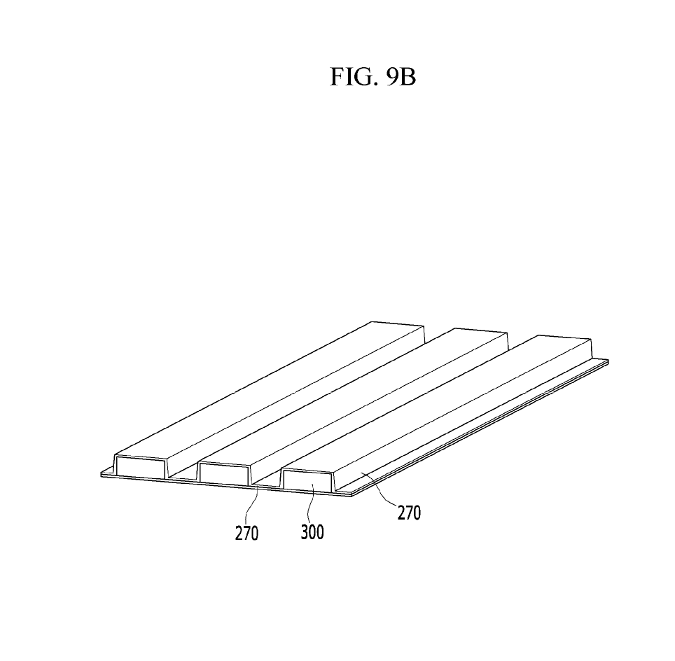

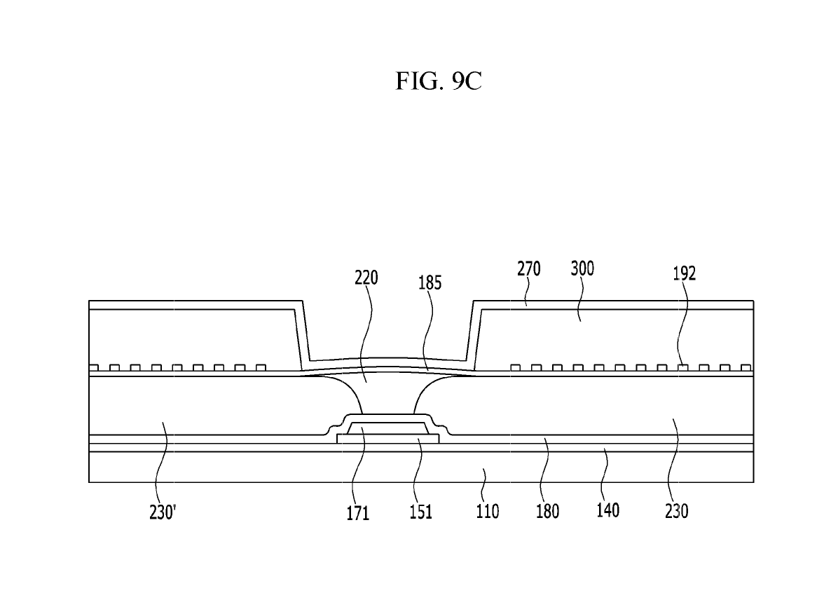

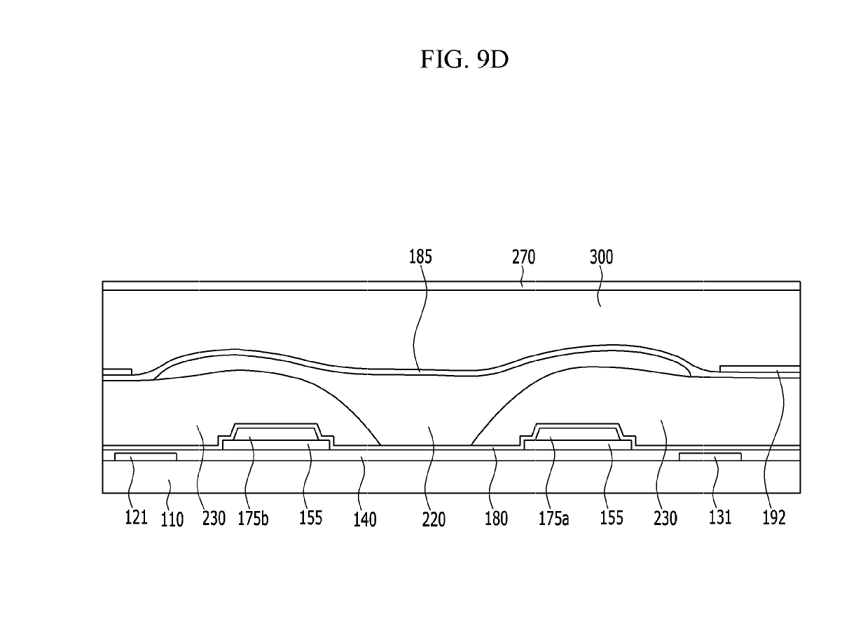

Next, as illustrated in FIGS. 9A to 9D, the sacrificial layer 300 is formed, and then the common electrode 270 is sequentially formed thereon. The sacrificial layer 300 and the common electrode 270 as illustrated in FIGS. 9A to 9D are manufactured by the following method. Here, FIG. 9A is a layout view corresponding to FIG. 1, and FIG. 9B is a perspective view for describing the formation of the sacrificial layer 300 and the common electrode 270. FIG. 9C is a drawing corresponding to FIG. 2 and illustrates a cross-sectional view of the liquid crystal display formed up to FIG. 9A. FIG. 9D is a diagram corresponding to FIG. 3 and illustrates a cross-sectional view of the liquid crystal display formed up to FIG. 9A.

First, a process of forming the sacrificial layer 300 is described. As the material for the sacrificial layer, an organic layer, amorphous carbon, metal, or an inorganic layer is stacked on the whole surface of the liquid crystal panel on which the second passivation layer. Next, the structure of the sacrificial layer 300 is formed by etching the material for the stacked sacrificial layer. The material for the sacrificial layer may include an organic layer, amorphous carbon, metal, or an inorganic layer, and thus different etching methods or etchants depending on each material may be used. As illustrated in FIG. 9A, the sacrificial layer 300 is formed lengthwise along pixels that extend along the extending direction of the data line 171 and are adjacent vertically. The sacrificial layer 300 is not formed over the data line 171

When the sacrificial layer 300 is not formed as an organic layer like a photoresist (PR), and the sacrificial layer 300 is formed of amorphous carbon, metal, or an inorganic layer, the sides of the sacrificial layer 300 have an angle of 90°±10° and thus may have approximately a vertical structure.

Next, transparent conductive materials such as ITO and IZO are stacked over the whole area of the structure of the sacrificial layer 300 to form the common electrode 270. The common electrodes 270 are positioned on the upper surface and the sides of the sacrificial layer 300 and extend along the upper surface and the sides of the sacrificial layer 300. The extending direction of the common electrode 270 may be an extending direction of the gate line 121.

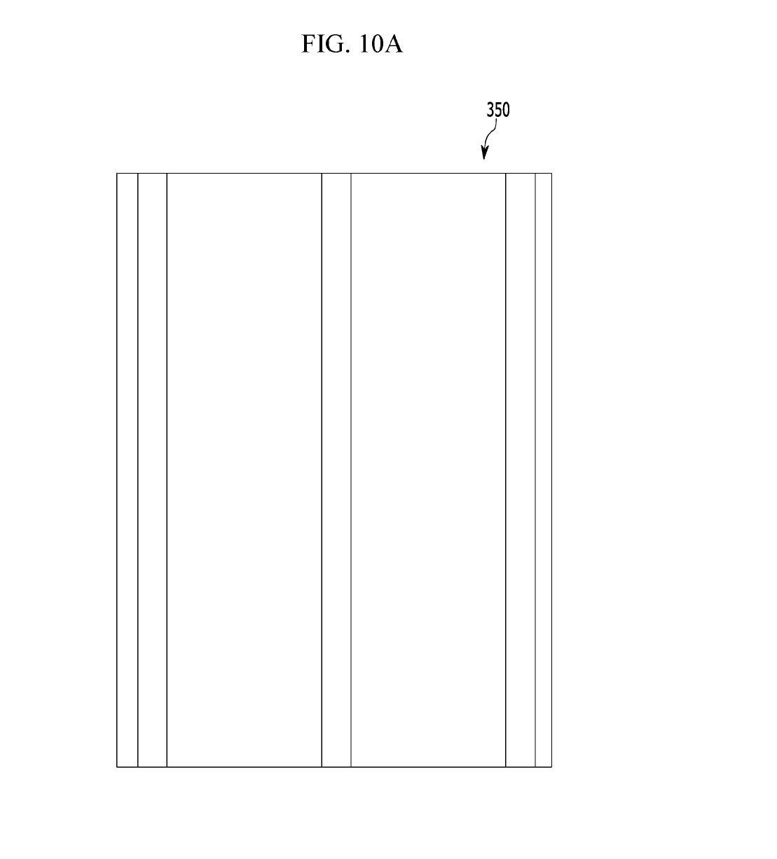

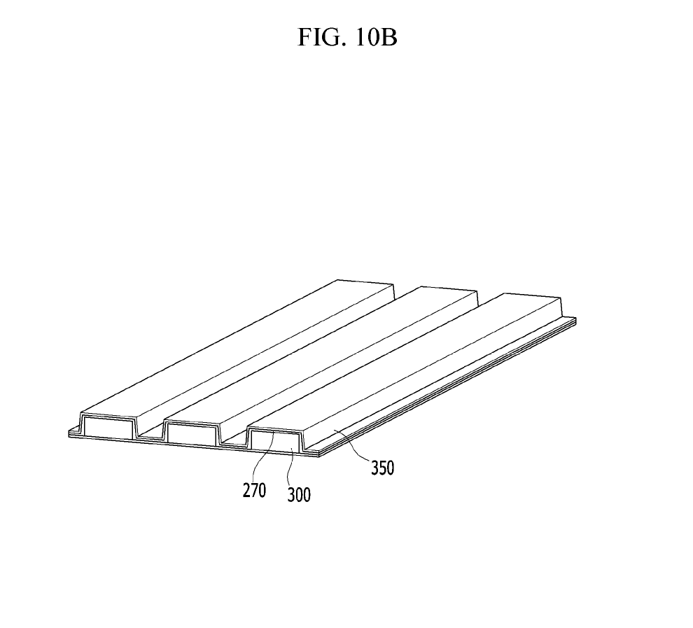

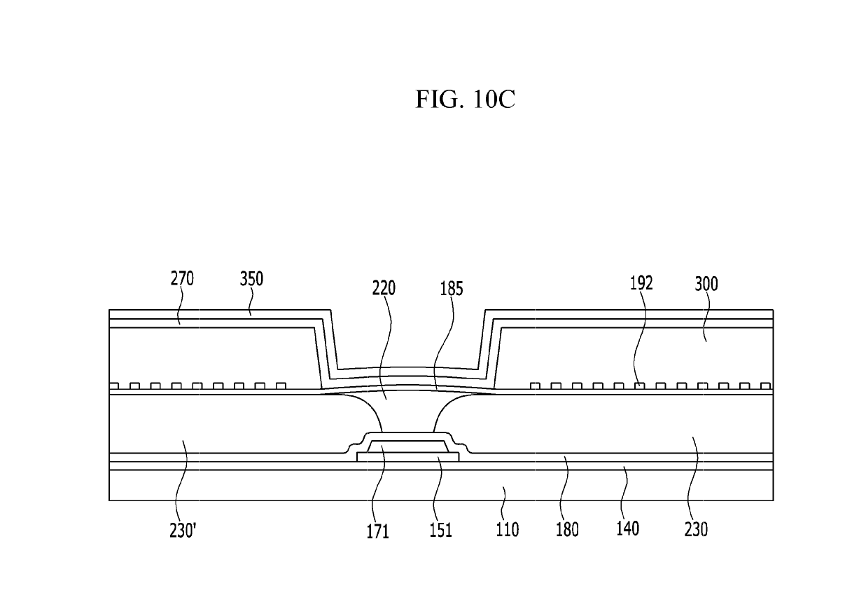

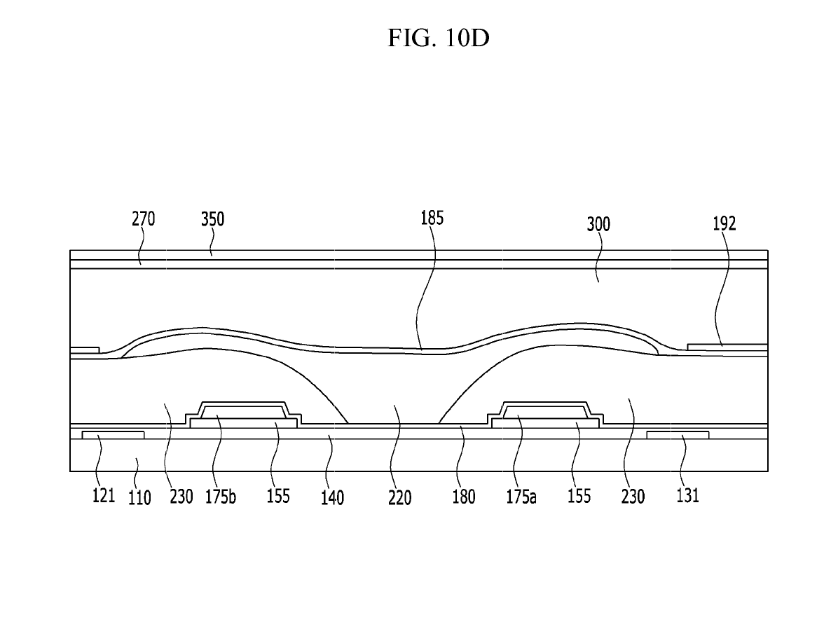

Next, as illustrated in FIGS. 10A to 10D, the lower insulating layer 350 that is positioned on the common electrode 270 and includes inorganic insulating materials, such as silicon nitride (SiNx), is formed over the whole surface of the liquid crystal panel. The lower insulating layer 350 covers the common electrode 270. Here, FIG. 10A is a layout view corresponding to FIG. 1, and FIG. 10B is a perspective view for describing a form of the sacrificial layer 300, the common electrode 270, and the lower insulating layer 350. FIG. 100 is a diagram corresponding to FIG. 2 and illustrates a cross-sectional view of the liquid crystal display formed up to FIG. 10A FIG. 10D is a diagram corresponding to FIG. 3 and illustrates a cross-sectional view of the liquid crystal display formed up to FIG. 10A.

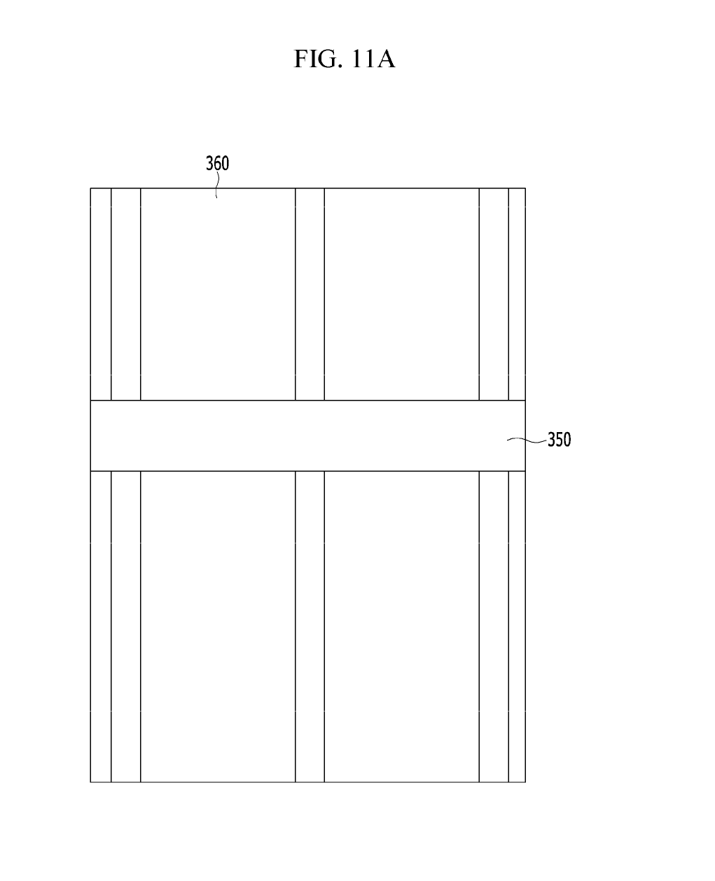

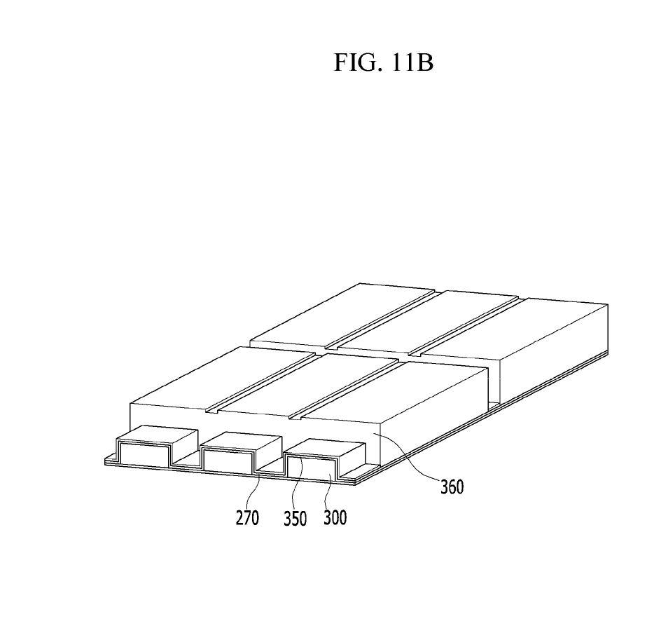

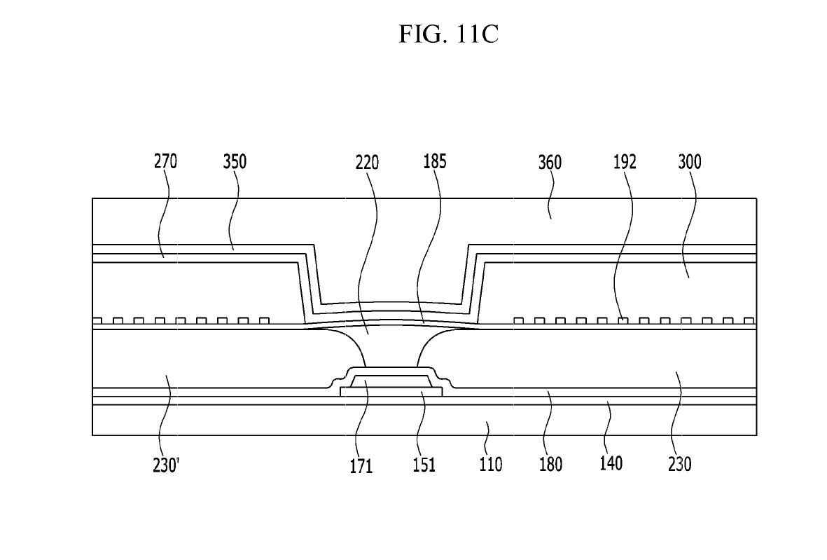

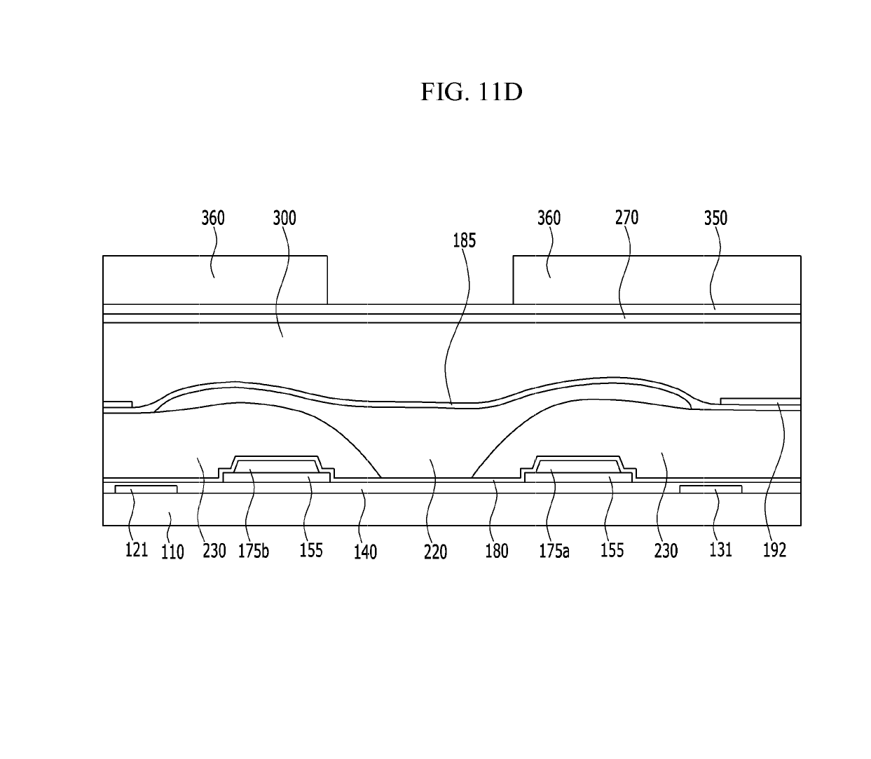

Next, the roof layer 360 is formed as illustrated in FIGS. 11A to 11D. The roof layer 360 may be formed and include an organic material. The roof layer 360 is not formed in the region (hereinafter, referred to as a ‘liquid crystal injection hole open region’) etched by the process of forming the liquid crystal injection hole 307. Here, FIG. 11A is a layout view corresponding to FIG. 1, and FIG. 11B is a perspective view for describing the formation of the sacrificial layer 300, the common electrode 270, the lower insulating layer 360, and the roof layer 360. FIG. 11C is a diagram corresponding to FIG. 2 and illustrates a cross-sectional view of the liquid crystal display formed up to FIG. 11A. FIG. 11D is a diagram corresponding to FIG. 3 and illustrates a cross-sectional view of the liquid crystal display formed up to FIG. 11A.

FIG. 11A illustrates that the liquid crystal injection hole open region is formed corresponding to the thin film transistor forming region in which the liquid crystal injection hole open region has a structure extending along a direction in which the gate line is formed. Further, the roof layer 360 is not formed in the corresponding region and therefore the generally formed lower insulating layer 350 is exposed.

The roof layer 360 may be formed by stacking a material for the roof layer including the organic material in the whole panel region, exposing and developing the material using the mask, and then removing the material for the roof layer of the region in which the liquid crystal injection hole 307 is formed. The lower insulating layer 350 formed in the lower portion of the roof layer 360 is not etched and thus is exposed. Only the common electrode 270 and the lower insulating layer 350 are formed on the sacrificial layer 300 in the liquid crystal injection hole open region, and the sacrificial layer 300, the common electrode 270, the lower insulating layer 350, and the roof layer 360 are stacked in other regions.

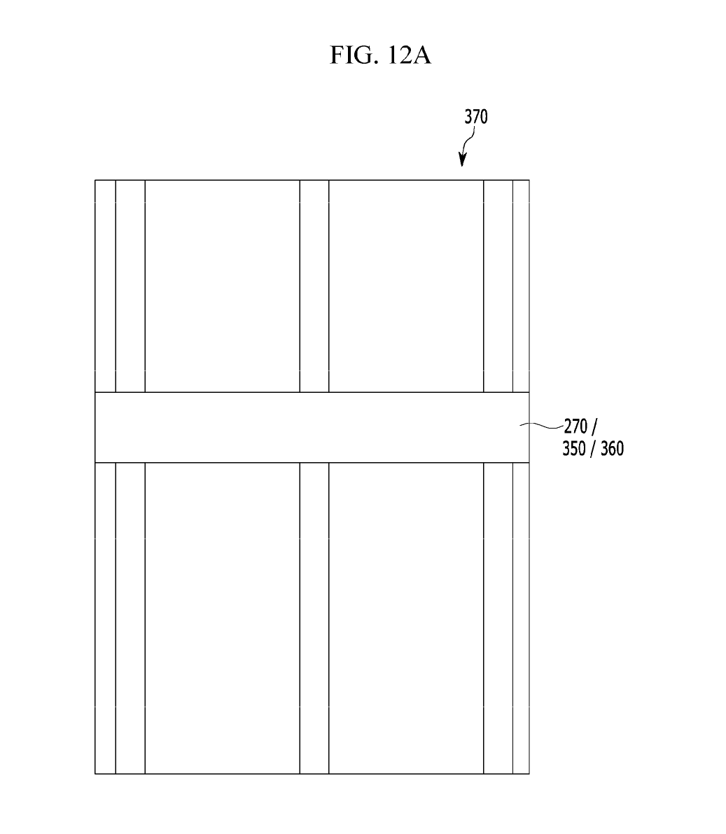

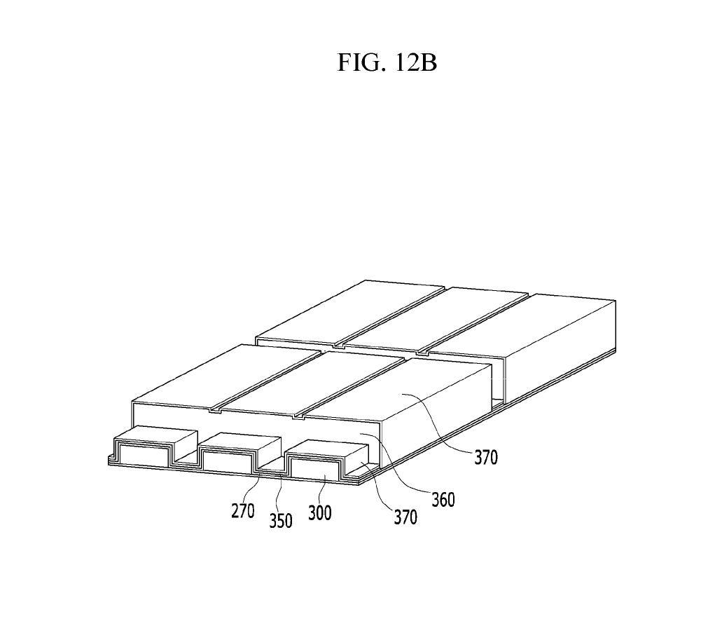

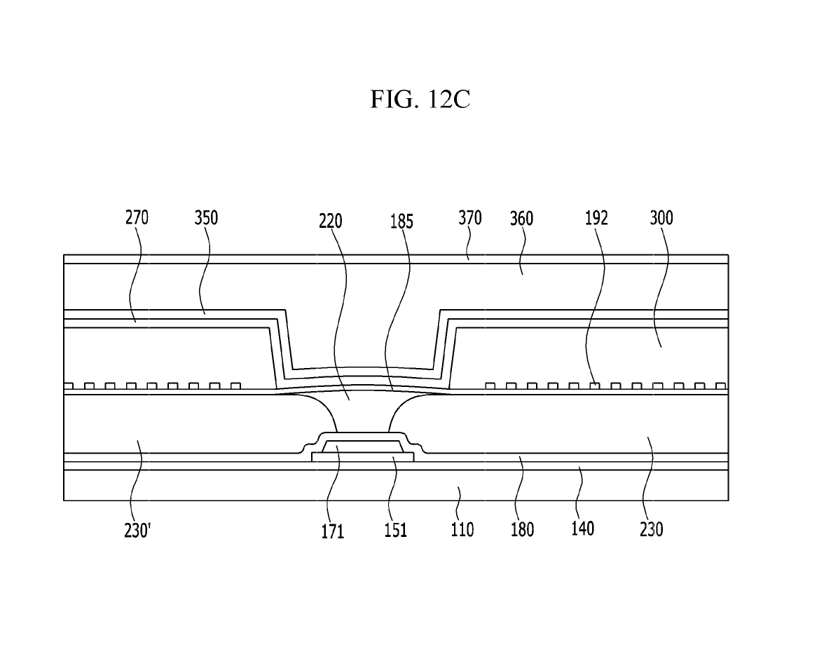

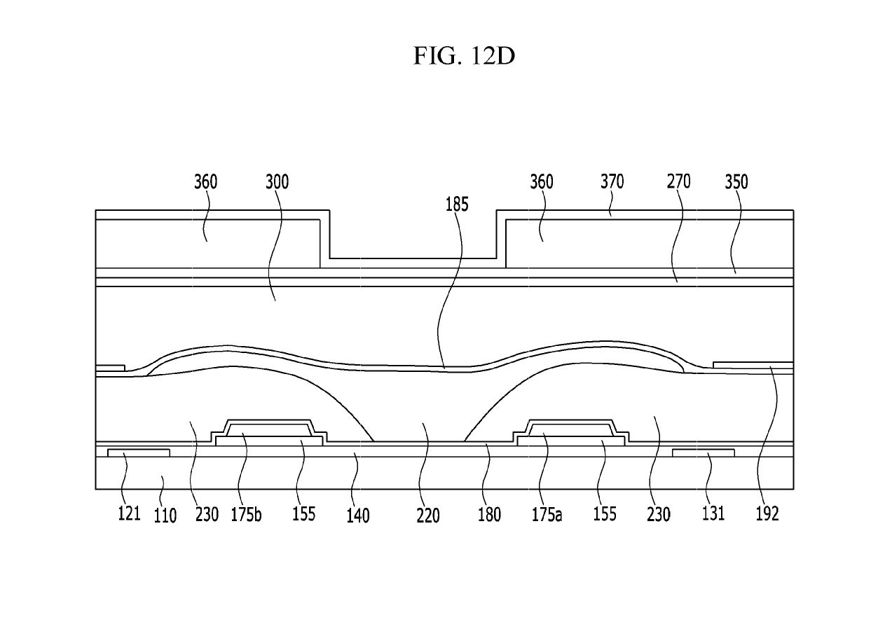

Next, as illustrated in FIGS. 12A to 12D, the upper insulating layer 370 is formed on the whole surface of the liquid crystal panel by stacking the material for the upper insulating layer including the inorganic insulating material such as silicon nitride (SiNx). Here, FIG. 12A is a layout view corresponding to FIG. 1, and FIG. 12B is a perspective view for describing a form of the sacrificial layer 300, the common electrode 270, the lower insulating layer 350, the roof layer 360, and the upper insulating layer 370. FIG. 12C is a diagram corresponding to FIG. 2 and illustrates a cross-sectional view of the liquid crystal display formed up to FIG. 12A. FIG. 12D is a diagram corresponding to FIG. 3 and illustrates a cross-sectional view of the liquid crystal display formed up to FIG. 12A.

Next, as illustrated in FIGS. 13A and 13E, the liquid crystal injection hole 307 is formed by etching the liquid crystal injection hole open region. Here, FIG. 13A is a layout view corresponding to FIG. 1, and FIGS. 13B and 13C are perspective views for describing the process of forming the liquid crystal injection hole 307. FIG. 13D is a diagram corresponding to FIG. 2 and illustrates a cross-sectional view of the liquid crystal display formed up to FIG. 13A. FIG. 13E is a diagram corresponding to FIG. 3 and illustrates a cross-sectional view of the liquid crystal display formed up to FIG. 13A.

Describing in detail, as illustrated in FIG. 13B, the lower insulating layer 350 and the upper insulating layer 370 formed in the liquid crystal injection hole open region among the upper insulating layer 370 and the lower insulating layer 350 stacked over the whole region of the liquid crystal panel are etched by the inorganic insulating material such as silicon nitride (SiNx). Next, the sacrificial layer 300 is exposed by etching the common electrode 270 formed in the liquid crystal injection hole open region. According to an exemplary embodiment of the present disclosure, the lower insulating layer 350, the upper insulating layer 370, and the common electrode 270 may also be etched by the same etching process.

To etch the liquid crystal injection hole open region, the photoresist (PR) is formed in the whole region, and the photoresist (PR) corresponding to the liquid crystal injection hole open region is removed to form the photoresist pattern, which is then is etched depending on the photoresist (PR) pattern to form the liquid crystal injection hole open region. In this case, the upper insulating layer 370, the lower insulating layer 350, the common electrode 270, and the sacrificial layer 300 in the liquid crystal injection hole open region are etched, and the layer thereunder is not etched. According to some exemplary embodiments of the present disclosure, the sacrificial layer 300 may partially be etched or may not be etched. Here, the process of etching the liquid crystal injection hole open region may be performed by dry etching or wet etching.

Next, as illustrated in FIGS. 13C to 13E, the exposed sacrificial layer 300 is removed. According to an exemplary embodiment of the present disclosure, the sacrificial layer 300 is formed of an organic layer, that is, amorphous carbon, metal, or an inorganic layer, and therefore, the sacrificial layer 300 may be removed by wet etching or dry etching depending on each material.

Meanwhile, the photoresist pattern formed to etch the liquid crystal injection hole open region may be removed using a separate photoresist stripper.

Next, as illustrated in FIG. 14, the alignment layer 11 is formed inside the microcavity 305. In detail, when an alignment solution including an alignment material is dropped by an inkjet method, the alignment solution is injected into the microcavity 305 through the liquid crystal injection hole 307 by capillary force. Next, a solution component of the alignment solution is evaporated during a hardening process, and the alignment material remains in an inner wall of the microcavity 305 to form the alignment layer 11.

Next, as illustrated in FIG. 15, the liquid crystal layer 3 is injected into the microcavity 305. In detail, when the liquid crystal material including the liquid crystal molecules 310 is dispersed by the inkjet method, the liquid crystal material is injected into the microcavity 305 through the liquid crystal injection hole 307 by capillary force to form the liquid crystal layer 3.

Next, the microcavity 305 is covered with the capping layer 390 illustrated in FIGS. 16A to 16C, and the liquid crystal injection hole 307 is encapsulated to prevent the liquid crystal layer 3 injected into the microcavity 305 from leaking to the outside. The capping layer 390 may be made of a transparent insulating material that does not react with the liquid crystal molecules 310.

Here, FIG. 16A is a layout view illustrating the capping layer 390, which covers the plurality of pixel areas (herein, a 6×3 pixel area illustrated) disposed in the horizontal direction (gate line direction) and the vertical direction (data line direction). FIG. 16B is a cross-sectional view illustrating a cross section of the capping layer 390 taken along the line XVI-B of FIG. 16A. FIG. 16C is a cross-sectional view illustrating a cross section of the capping layer 390 taken along the line XVI-C of FIG. 16A.

The capping layer 390 may be provided as a film of which the lower surface is patterned in an engaging shape corresponding to the trench shape of the liquid crystal injection hole 307, and the upper surface is patterned to form an arrangement of lenticular lenses for displaying autostereoscopic images. The engaging shape of the lower surface of the capping layer 390 includes a horizontal part 392 that contacts the upper insulating layer 370 and a plurality of engaging parts 393 that extends in the horizontal direction to engage with the liquid crystal injection hole 307. The arrangement shape of the lenticular lenses on the upper surface of the capping layer 390 includes a plurality of lenticular lens parts 391 that extend in a vertical direction. Each of the lenticular lens parts 391 covers a plurality of pixel areas in the horizontal direction.

The capping layer 390 is positioned on the upper insulating layer 370 so that the engaging part 393 of the capping layer 390 engages with the liquid crystal injection hole 307, thereby forming the lenticular lens layer for displaying the stereoscopic image while encapsulating the liquid crystal injection hole 307.

FIG. 16A illustrates a case in which the capping layer 390 forms the single lenticular lens part 391 in the horizontal direction and corresponds to six pixel areas. FIG. 16A is only an example and does not limit the present disclosure. The single lenticular lens part 391 may be formed to cover N points of view (N is a natural number). For example, the single lenticular lens part 391 may cover nine points of view. One point of view corresponds to one pixel, which includes a red sub-pixel, a green sub-pixel, and a blue sub-pixel. One sub-pixel may correspond to one pixel area.

According to the manufacturing method in accordance with the exemplary embodiment of the present disclosure as described above, the upper surface of the capping layer 390 is patterned in the arrangement shape of the lenticular lenses, and therefore, the separate process of additionally attaching the lenticular lens layer may be omitted.

The accompanying drawings and the detailed description of the present disclosure are only examples of the present system and method and do not limit the meaning or the scope of the present system and method described in the appended claims. Therefore, those of ordinary skill in the art would appreciate that various modifications and other equivalent embodiments are available.

While the present system and method have been described in connection with exemplary embodiments, the present system and method are not limited to the disclosed embodiments. On the contrary, the present system and method cover various modifications and equivalent arrangements included within the spirit and scope of the appended claims.

### DESCRIPTION OF SYMBOLS

| | |
|---|---|
| 110: Insulating substrate | 121: Gate line |
| 124: Gate electrode | 131: Sustain voltage line |
| 140: Gate insulating layer | 151, 154, 155: Semiconductor |
| 171: Data line | 173: Source electrode |
| 175: Drain electrode | 180, 185: Passivation layer |
| 186: Contact hole | 192: Pixel electrode |
| 220: Black matrix | 230: Color filter |
| 270: Common electrode | 3: Liquid crystal layer |
| 300: Sacrificial layer | 305: Microcavity layer |
| 307: Liquid crystal injection hole | 350: Lower insulating layer |
| 360: Roof layer | 370: Upper insulating layer |
| 390: Capping layer | 391: Lenticular lens part |
| 392: Horizontal part | 393: Engaging part |

What is claimed is:

1. A liquid crystal display, comprising:
an insulation substrate;
a microcavity formed on the insulating substrate and having an upper surface and sides;
a liquid crystal layer injected into the microcavity;
liquid crystal injection holes formed on one side of the microcavity to inject a liquid crystal into the microcavity; and
a capping layer formed on the microcavity and having an upper surface patterned to form an arrangement of lenticular lenses.

2. The liquid crystal display of claim 1, wherein:
a lower surface of the capping layer is patterned in an engaging shape corresponding to a shape of the liquid crystal injection hole, and the liquid crystal injection hole is encapsulated with the capping layer.

3. The liquid crystal display of claim 2, wherein:
the upper surface of the capping layer includes a plurality of lenticular lens parts extending in a vertical direction.

4. The liquid crystal display of claim 3, wherein:
any one of the plurality of lenticular lens parts covers a plurality of pixel areas disposed in a horizontal direction.

5. The liquid crystal display of claim 3, wherein:
any one of the plurality of lenticular lens parts covers a plurality of points of view.

6. The liquid crystal display of claim 3, further comprising:
a pixel electrode formed in the microcavity; and
a common electrode positioned on the liquid crystal layer,
wherein the common electrode extends along the upper surface and the sides of the microcavity.

7. The liquid crystal display of claim 6, wherein:
the common electrode is formed as a plurality of common electrodes.

8. The liquid crystal display of claim 7, further comprising:
a roof layer covering the common electrode.

9. A manufacturing method of a liquid crystal display, comprising:
stacking a material for a sacrificial layer;
forming the sacrificial layer by etching the material for the sacrificial layer;
forming common electrodes that extend along an upper surface and sides of the sacrificial layer;
forming a roof layer covering the sacrificial layer;
forming a liquid crystal injection hole through which the sacrificial layer is exposed;
forming a microcavity by removing the sacrificial layer through the liquid crystal injection hole;
forming a liquid crystal layer in the microcavity through the liquid crystal injection hole; and
covering the microcavity with a capping layer of which the upper surface is patterned to form an arrangement of lenticular lenses.

10. The manufacturing method of claim 9, wherein:
a lower surface of the capping layer is patterned in an engaging shape corresponding to a shape of the liquid crystal injection hole, and the liquid crystal injection hole is encapsulated with the capping layer.

11. The manufacturing method of claim 10, wherein:
the upper surface of the capping layer includes a plurality of lenticular lens parts extending in a vertical direction.

12. The manufacturing method of claim 11, wherein:
any one of the plurality of lenticular lens parts covers a plurality of pixel areas disposed in a horizontal direction.

13. The manufacturing method of claim 11, wherein:
any one of the plurality of lenticular lens parts covers a plurality of points of view.

14. The manufacturing method of claim 9, further comprising:
forming a pixel electrode of a transparent conductive material in a lower portion of the sacrificial layer.

15. The manufacturing method of claim 14, further comprising:
prior to forming the liquid crystal layer in the microcavity, forming an alignment layer in the microcavity through the liquid crystal injection hole.

16. The manufacturing method of claim 9, wherein:
the sacrificial layers formed in the forming of the sacrificial layer are formed lengthwise along vertically adjacent pixels.

17. The manufacturing method of claim 9, wherein:
the roof layer is not formed in a region in which the liquid crystal injection hole is formed.

18. The manufacturing method of claim 17, further comprising:
forming a lower insulating layer covering the common electrode prior to forming the roof layer; and
forming an upper insulating layer covering the roof layer and the exposed lower insulating layer after forming the roof layer.

19. The manufacturing method of claim 18, wherein:
the forming of the liquid crystal injection hole includes
etching the common electrode, the lower insulating layer, and the upper insulating layer.
